(19) United States
(12) Patent Application Publication
(10) Pub. No.: US 2007/0033592 A1
(43) Pub. Date: Feb. 8, 2007

(54) Method, apparatus, and computer program product for adaptive process dispatch in a computer system having a plurality of processors

(75) Inventors: Robert Ralph Roediger, Rochester, MN (US); William Jon Schmidt, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 11/197,605

(22) Filed: Aug. 4, 2005

(51) Int. Cl. G06F 9/46; G06F 9/45

(52) U.S. Cl. 718/102; 717/148

(57) ABSTRACT

A run-time feature set of a process or a thread is generated and compared to at least one processor feature set. Each processor feature set represents zero or more optional hardware features supported by one or more processors, whereas the run-time feature set represents zero or more optional hardware features the process or thread relies upon. The comparison of the feature sets determines whether a particular process or thread may run on a particular processor, even in a heterogeneous processor environment. A system task dispatcher assigns the process or thread to execute on one or more processors indicated by the comparison as being compatible with the process or thread. When a new feature is added to the process or thread, the run-time feature set is updated and again compared to at least one processor feature set. The system task dispatcher reassigns the process or thread if necessary.

### CROSS-REFERENCE TO RELATED APPLICATION

This patent application is related to a pending U.S. patent application ______ (docket no. ROC920050022US1), filed concurrently, entitled “METHOD, APPARATUS, AND COMPUTER PROGRAM PRODUCT FOR ADAPTIVELY GENERATING CODE FOR A COMPUTER PROGRAM”, which is assigned to the assignee of the instant application.

### BACKGROUND OF THE INVENTION

1. Field of Invention

The present invention relates in general to the digital data processing field. More particularly, the present invention relates to adaptive process dispatch in computer systems having a plurality of processors.

2. Background Art

In the latter half of the twentieth century, there began a phenomenon known as the information revolution. While the information revolution is a historical development broader in scope than any one event or machine, no single device has come to represent the information revolution more than the digital electronic computer. The development of computer systems has surely been a revolution. Each year, computer systems grow faster, store more data, and provide more applications to their users.

A modem computer system typically comprises at least one central processing unit (CPU) and supporting hardware necessary to store, retrieve and transfer information, such as communications buses and memory. It also includes hardware necessary to communicate with the outside world, such as input/output controllers or storage controllers, and devices attached thereto such as keyboards, monitors, tape drives, disk drives, communication lines coupled to a network, etc. The CPU or CPUs are the heart of the system. They execute the instructions which comprise a computer program and direct the operation of the other system components.

The overall speed of a computer system is typically improved by increasing parallelism, and specifically, by employing multiple CPUs (also referred to as processors). The modest cost of individual processors packaged on integrated circuit chips has made multi-processor systems practical, although such multiple processors add more layers of complexity to a system.

From the standpoint of the computer's hardware, most systems operate in fundamentally the same manner. Processors are capable of performing very simple operations, such as arithmetic, logical comparisons, and movement of data from one location to another. But each operation is performed very quickly. Sophisticated software at multiple levels directs a computer to perform massive numbers of these simple operations, enabling the computer to perform complex tasks. What is perceived by the user as a new or improved capability of a computer system is made possible by performing essentially the same set of very simple operations, using software having enhanced function, along with faster hardware.

In the very early history of the digital computer, computer programs which instructed the computer to perform some task were written in a form directly executable by the computer's processor. Such programs were very difficult for a human to write, understand and maintain, even when performing relatively simple tasks. As the number and complexity of such programs grew, this method became clearly unworkable. As a result, alternative forms of creating and executing computer software were developed. In particular, a large and varied set of high-level languages was developed for supporting the creation of computer software.

High-level languages vary in their characteristics, but all such languages are intended to make it easier for a human to write a program to perform some task. Typically, high-level languages represent instructions, fixed values, variables, and other constructs in a manner readily understandable to the human programmer rather than the computer. Such programs are not directly executable by the computer's processor. In order to run on the computer, the programs must first be transformed into a form that the processor can execute.

Transforming a high-level language program into executable form requires the human-readable program form (i.e., source code) be converted to a processor-executable form (i.e., object code). This transformation process generally results in some loss of efficiency from the standpoint of computer resource utilization. Computers are viewed as cheap resources in comparison to their human programmers. High-level languages are generally intended to make it easier for humans to write programming code, and not necessarily to improve the efficiency of the object code from the computer's standpoint. The way in which data and processes are conveniently represented in high-level languages does not necessarily correspond to the most efficient use of computer resources, but this drawback is often deemed acceptable in order to improve the performance of human programmers.

While certain inefficiencies involved in the use of high-level languages may be unavoidable, it is nevertheless desirable to develop techniques for reducing inefficiencies where practical. This has led to the use of compilers and so-called “optimizing” compilers. A compiler transforms source code to object code by looking at a stream of instructions, and attempting to use the available resources of the executing computer in the most efficient manner. For example, the compiler allocates the use of a limited number of registers in the processor based on the analysis of the instruction stream as a whole, and thus hopefully minimizes the number of load and store operations. An optimizing compiler might make even more sophisticated decisions about how a program should be encoded in object code. For example, the optimizing compiler might determine whether to encode a called procedure in the source code as a set of in-line instructions in the object code.

Processor architectures (e.g., Power, x86, etc.) are commonly viewed as static and unchanging. This perception is inaccurate, however, because processor architectures are properly characterized as extensible. Although the majority of processor functions typically do remain stable throughout the architecture's lifetime, new features are added to processor architectures over time. A well known example of this extensibility of processor architecture was the addition of a floating-point unit to the x86 processor architecture, first as an optional co-processor, and eventually as an integrated part of every x86 processor chip. Thus, even within the same processor architecture, the features possessed by one processor may differ from the features possessed by another processor.

When a new feature is added to a processor architecture, software developers are faced with a difficult choice. A computer program must be built either with or without instructions supported by the new feature. A computer program with instructions requiring the new feature is either incompatible with older hardware models that do not support these instructions and cannot be used with them, or older hardware models must use emulation to support these instructions. Emulation works by creating a trap handler that captures illegal instruction exceptions, locates the offending instruction, and emulates its behavior in software. This may require hundreds of instructions to emulate a single unsupported instruction. The resulting overhead may cause unacceptable performance delays when unsupported instructions are executed frequently.

If emulation is not acceptable for a computer program, developers may choose either to limit the computer program to processors that support the new feature, or to build two versions of the computer program, i.e., one version that uses the new feature and another version that does not use the new feature. Both of these options are disadvantageous. Limiting the computer program to processors that support the new features reduces the market reach of the computer program. Building two versions of the computer program increases the cost of development and support.

In certain object-oriented virtual machine (VM) environments, such as the Java and .NET virtual machines, this compatibility problem is solved by using just-in-time (JIT) compilation. A JIT compiler recompiles code from a common intermediate representation each time a computer program is loaded into the environment. Each computer may have a different JIT compiler that takes advantage of the features present on that computer. This is very helpful, but only in VM environments.

Because of the problems involved with exploiting new features, software developers typically will not do so until the features become common on all supported computers on their platform. This often leads to an extraordinarily lengthy time lapse between introduction of the hardware features and their general acceptance. For example, five or more years may pass between implementation of a new hardware feature and its exploitation.

Moreover, additional problems involved with exploiting new features arise in the context of heterogeneous processor environments. An example of a heterogeneous processor environment is a multi-processor computer system wherein different models of the same processor family simultaneously co-exist. This contrasts with a homogeneous processor environment, such as a multi-processor computer system wherein each processor is the same model. In a heterogeneous processor environment, problems may arise when dispatching a computer program requiring a particular feature that is present on some processor models in a processor family but is not present on other processor models in the same processor family. That is, the computer program may be dispatched to a processor lacking the required feature.

A need exists for a more flexible system that allows computer programs to automatically take advantage of new hardware features when they are present in a heterogeneous processor environment, and avoid using them when they are absent.

### SUMMARY OF THE INVENTION

According to a preferred embodiment of the present invention a run-time feature set of a process or a thread is generated and compared to at least one processor feature set. The processor feature set represents zero, one or more optional hardware features supported by one or more of the processors, whereas the run-time feature set represents zero, one or more optional hardware features the process or the thread relies upon (i.e., zero, one or more optional hardware features that are required to execute code contained in the process or the thread). A comparison of the feature sets determines whether a particular process or thread may run on a particular processor, even in a heterogeneous processor environment. A system task dispatcher assigns the process or the thread to execute on one or more of the processors indicated by the comparison as being compatible with the process or the thread. When a new feature is added to the process or the thread, the run-time feature set is updated and again compared to at least one processor feature set. The system task dispatcher reassigns the process or the thread if necessary.

The foregoing and other features and advantages of the present invention will be apparent from the following more particular description of the preferred embodiments of the present invention, as illustrated in the accompanying drawings.

### BRIEF DESCRIPTION OF THE DRAWINGS

The preferred embodiments of the present invention will hereinafter be described in conjunction with the appended drawings, where like designations denote like elements.

FIG. 1 is a block diagram of a multi-processor computer system in accordance with the preferred embodiments of the present invention.

FIG. 2 is a schematic diagram showing an exemplary format of a processor feature set in accordance with preferred embodiments of adaptive code generation.

FIG. 3 is a schematic diagram showing an exemplary format of a program feature set in accordance with preferred embodiments of adaptive code generation.

FIG. 4 is a flow diagram showing a method for adaptive process dispatch by generating a run-time feature set of a process or a thread in accordance with the preferred embodiments of the present invention.

FIG. 5 is a flow diagram showing a method for adaptive process dispatch by generating a run-time feature set of a child process in accordance with the preferred embodiments of the present invention.

FIG. 6 is a flow diagram showing a method for adaptive process dispatch by generating an updated run-time feature set of a process when an additional load unit is requested to be loaded in accordance with the preferred embodiments of the present invention.

### DETAILED DESCRIPTION OF THE PREFERRED EMBODIMENTS

1.0 Overview

Adaptive process dispatch (or adaptive processor selection) in accordance with the preferred embodiments of the present invention relies upon feature sets, such as program feature sets and processor feature sets. The provenance of these feature sets is unimportant for purposes of the present invention. For example, the program feature sets may be created by adaptive code generation or some other mechanism in a compiler, or by some analysis tool outside of a compiler. With regard to adaptive code generation, it is significant to note that the present invention allows the use of adaptive code generation in heterogeneous processor environments. As noted above, this patent application is related to a pending U.S. patent application ______ (docket no. ROC920050022US1), filed concurrently, entitled “METHOD, APPARATUS, AND COMPUTER PROGRAM PRODUCT FOR ADAPTIVELY GENERATING CODE FOR A COMPUTER PROGRAM”, which is assigned to the assignee of the instant application. An understanding of adaptive code generation is helpful in understanding the present invention. For those not familiar with adaptive code generation, the following Adaptive Code Generation section will provide background information that will help to understand the present invention.

### Adaptive Code Generation

Adaptive code generation provides a flexible system that allows computer programs to automatically take advantage of new hardware features when they are present, and avoid using them when they are absent. Adaptive code generation works effectively on both uni-processor and multi-processor computer systems when all processors on the multi-processor computer system are homogeneous. When not all processors are homogeneous (i.e., a heterogeneous processor environment), additional mechanisms are necessary to ensure correct execution. These mechanisms are the subject of the present application.

Adaptive code generation (or model dependent code generation) is built around the concept of a hardware feature set. The concept of a hardware feature set is used herein (both with respect to adaptive code generation, which is discussed in this section, and adaptive process dispatch, which is discussed in the following section) to represent optional features in a processor architecture family. This includes features which have not been and are not currently optional but which may not be available on future processor models in the same architecture family. Each element of a feature set represents one “feature” that is present in some processor models in an architecture family but is not present in other processor models in the same architecture family. Different levels of granularity may be preferable for different features. For example, one feature might represent an entire functional unit (such as a single-instruction, multiple-data (SIMD) unit and/or graphics acceleration unit), while another feature might represent a single instruction or set of instructions. SIMD units are also referred to as vector processor units or vector media extension (VMX) units, as well as by various trade names such as AltiVec, Velocity Engine, etc.

In general, a feature may represent an optional entire functional unit, an optional portion of a functional unit, an optional instruction, an optional set of instructions, an optional form of instruction, an optional performance aspect of an instruction, or an optional feature elsewhere in the architecture (e.g., in the address translation hardware, the memory nest, etc.). A feature may also represent two or more of the above-listed separate features that are lumped together as one.

A feature set is associated with each different processor model (referred to herein as a “feature set of the processor” or “processor feature set”), indicating the features supported by that processor model. The presence of a feature in a processor feature set constitutes a contract that the code generated to take advantage of that feature will work on that processor model. A feature set is also associated with each program (referred to herein as a “feature set of the program” or “program feature set”), indicating the features that the program relies upon (i.e., the optional hardware features that are required to execute code contained in an object, either a module or program object). That is, the program feature set is recorded based on the use by a module or program object of optional hardware features.

In accordance with preferred embodiments of adaptive code generation, each module or program object will contain a program feature set indicating the features that the object depends on in order to be used. A program will not execute on a processor model without all required features unless the program is rebuilt.

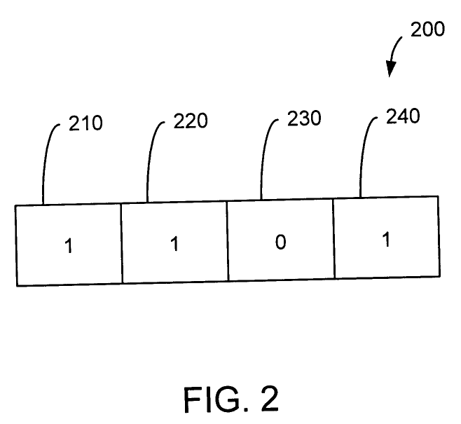

FIG. 2 illustrates an exemplary format of a processor feature set. The processor feature set format shown in FIG. 2 is one of any number of possible formats and is shown for illustrative purposes. Those skilled in the art will appreciate that the spirit and scope of adaptive code generation is not limited to any one format of the processor feature set. Referring again to FIG. 2, a processor feature set 200 includes a plurality of fields 210, 220, 230 and 240. Depending on the particular processor feature set, the various fields 210, 220, 230 and 240 each correspond to a particular feature and each has a “0” or “1” value. For example, field 210 may correspond to a SIMD unit, field 220 may correspond to a graphics acceleration unit, field 230 may correspond to a single instruction or set of instructions designed to support compression, and field 240 may correspond to a single instruction or set of instructions designed to support encryption. In the particular processor feature set 200 illustrated in FIG. 2, the values of the fields 210, 220, 230 and 240 indicate that the processor model with which the processor feature set 200 is associated includes a SIMD unit, a graphics acceleration unit, and the single instruction or set of instructions designed to support encryption, but not the single instruction or set of instructions designed to support compression. In addition, the format of the processor feature set may include one or more additional fields that correspond to features that are not currently optional but may not be available on future processor models in the processor architecture family and/or fields reserved for use with respect to other optional features that will be supported by the processor architecture family in the future. Also, the format of the processor feature set may include one or more fields each combining two or more features.

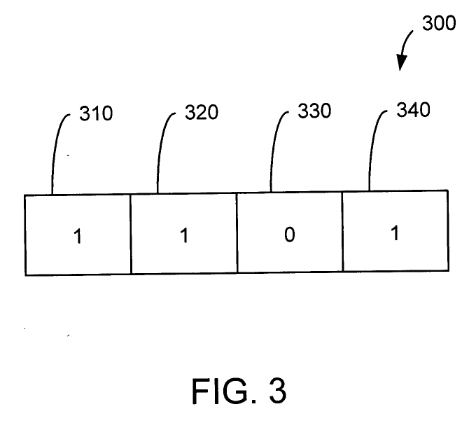

FIG. 3 illustrates an exemplary format of a program feature set. The program feature set format shown in FIG. 3 is one of any number of possible formats and is shown for illustrative purposes. Those skilled in the art will appreciate that the spirit and scope of adaptive code generation is not limited to any one format of the program feature set. Referring again to FIG. 3, a program feature set 300 includes a plurality of fields 310, 320, 330 and 340. Depending on the particular processor feature set, the various fields 310, 320, 330 and 340, each correspond to a particular feature and each has a “0” or “1” value. For example, field 310 may correspond to use of a SIMD unit, field 320 may correspond to use of a graphics acceleration unit, field 330 may correspond to use of a single instruction or set of instructions designed to support compression, and field 340 may correspond to use of a single instruction or set of instructions designed to support encryption. In the particular program feature set 300 illustrated in FIG. 3, the values of the fields 310, 320, 330 and 340 indicate that the computer program (module or program object) with which the program feature set 300 is associated uses a SIMD unit, a graphics acceleration unit, and the single instruction or set of instructions designed to support encryption in its code generation, but does not use the single instruction or set of instructions designed to support compression. In addition, the format of the program feature set may include one or more additional fields that correspond to the module or program object's use of features that are not currently optional but may not be available on future processor models in the processor architecture family and/or fields reserved for use with respect to the module or program object's use of other optional features that will be supported by the processor architecture family in the future. Also, the format of the program feature set may include one or more fields each combining use of two or more features.

As mentioned above, adaptive code generation works effectively on both uni-processor and multi-processor computer systems when all processors on the multi-processor computer system are homogeneous. Problems may arise, however, in the context of heterogeneous processor environments (e.g., a multi-processor computer system wherein different models of the same processor family simultaneously co-exist) when dispatching a computer program requiring a particular feature that is present on some processor models in a processor family but is not present on other processor models in the same processor family. That is, the computer program may be dispatched to a processor lacking the required feature.

Heterogeneous processor environments are not particularly common today, but will likely become much more common in the near future. A general trend exists to build large computer systems with many processors, and to make processor boards hot-swappable. It will likely be increasingly common for users to want to swap out some old processors and replace them with newer models, while some of the old processors remain on the computer system. For example, a user may determine that this slow upgrade technique, which produces a heterogeneous processor environment, is an economical way to upgrade a 64-processor computer system. The preferred embodiments of the present invention provide a more flexible system that allows computer programs to automatically take advantage of new hardware features when they are present in a heterogeneous processor environment, and avoid using them when they are absent.

2.0 Detailed Description

### Adaptive Process Dispatch

The preferred embodiments of the present invention generate a run-time feature set of a process or a thread which is compared to at least one processor feature set of a processor. This mechanism works effectively in either a homogeneous or heterogeneous processor environment. The processor feature set represents zero, one or more optional hardware features supported by one or more of the processors, whereas the run-time feature set represents zero, one or more optional hardware features the process or the thread relies upon (i.e., zero, one or more optional hardware features that are required to execute code contained in the process or the thread). That is, in accordance with the preferred embodiments of the present invention, a feature set (i.e., the run-time feature set) is associated with a running process or thread, as opposed to just static programs on disk as in adaptive code generation. A comparison of the feature sets (i.e., the run-time feature set and at least one processor feature set) determines whether a particular process or thread may run on a particular processor. A system task dispatcher assigns the process or the thread to execute on one or more of the processors indicated by the comparison as being compatible with the process or the thread. When a new feature is added to the process or the thread, the run-time feature set is updated and again compared to at least one processor feature set. The system task dispatcher reassigns the process or the thread if necessary.

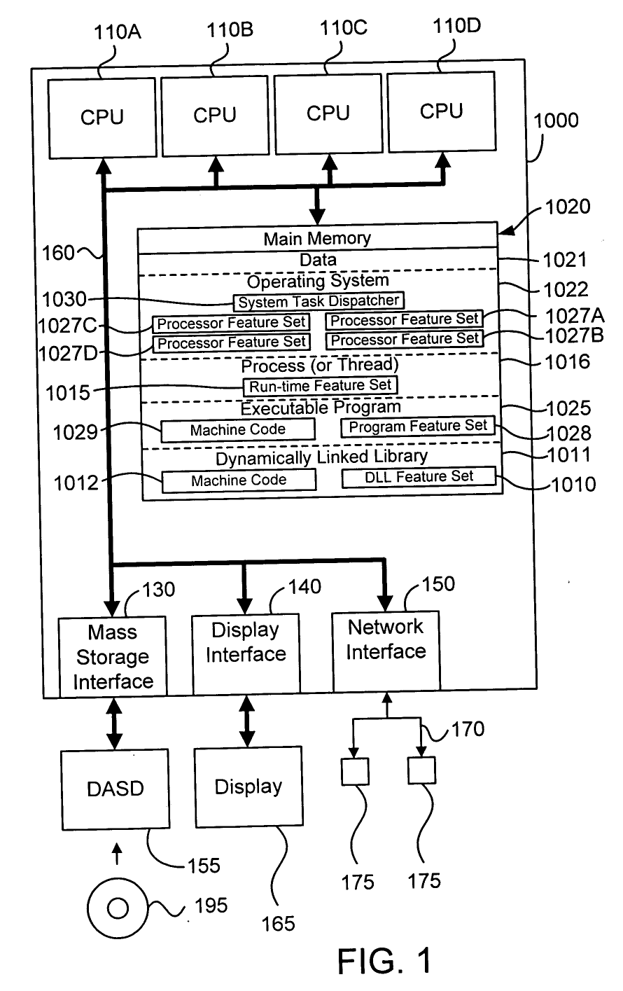

Referring now to FIG. 1, a computer system 1000 is one suitable implementation of an apparatus in accordance with preferred embodiments of the present invention. Computer system 1000 is an IBM eServer iSeries computer system. However, those skilled in the art will appreciate that the mechanisms and apparatus of the preferred embodiments of the present invention apply equally to any computer system regardless of whether the computer system is a complicated multi-user computing apparatus, a single user workstation, or an embedded control system. As shown in FIG. 1, computer system 1000 includes a plurality of processors 110A, 110B, 110C, and 110D, a main memory 1020, a mass storage interface 130, a display interface 140, and a network interface 150. These system components are interconnected through a bus system 160.

FIG. 1 is intended to depict the representative major components of computer system 1000 at a high level, it being understood that individual components may have greater complexity than represented in FIG. 1, and that the number, type and configuration of such components may vary. In particular, computer system 1000 may contain a different number of processors than shown.

Main memory 1020 preferably contains data 1021, an operating system 1022, a system task dispatcher 1030, a plurality of processor feature sets 1027A, 1027B, 1027C, and 1027D, a process or thread 1016, a run-time feature set 1015, an executable program 1025, a program feature set 1028, machine code 1029, a dynamically linked library 1011, a dynamically linked library feature set 1010, and machine code 1012. Data 1021 represents any data that serves as input to or output from any program in computer system 1000. Operating system 1022 is a multitasking operating system known in the industry as OS/400 or IBM i5/OS; however, those skilled in the art will appreciate that the spirit and scope of the present invention is not limited to any one operating system.

Process 1016 is created by operating system 1022. Processes typically contain information about program resources and program execution state. A thread (also denoted as element 1016 in FIG. 1) is a stream of computer instructions that exists within a process and uses process resources. A thread can be scheduled by the operating system to run as an independent entity within a process. A process can have multiple threads, with each thread sharing the resources within a process and executing within the same address space. According to the preferred embodiments of the present invention, process or thread 1016 is provided with a run-time feature set 1015.

Processors 110A, 110B, 110C, and 110D may be either homogeneous or heterogeneous in accordance with the preferred embodiments of the present invention. The present invention need not utilize adaptive code generation. However, the present invention permits adaptive code generation to be applied in a heterogeneous processor environment. Processors 110A, 110B, 110C, and 110D are members of a processor architecture family known in the industry as PowerPC AS architecture; however, those skilled in the art will appreciate that the spirit and scope of the present invention is not limited to any one processor architecture.

Multiple processor feature sets are required because processors 110A, 110B, 110C, and 110D may be heterogeneous. As shown in FIG. 1, processor feature set 1027A represents zero, one or more optional hardware features of the processor architecture family supported by processor 110A; processor feature set 1027B represents zero, one or more optional hardware features of the processor architecture family supported by processor 110B; processor feature set 1027C represents zero, one or more optional hardware features of the processor architecture family supported by processor 110C; and processor feature set 1027D represents zero, one or more optional hardware features of the processor architecture family supported by processor 110D. It is important to note that a separate processor feature set need not be present for each processor. Rather, a separate processor feature set need only be present for each heterogeneous processor group, i.e., a group of processors that support the same optional hardware features. For example, all of the processors within a particular heterogeneous processor group may share a single processor feature set.

The processor feature sets 1027A, 1027B, 1027C, and 1027D may have the same format as the exemplary processor feature set format shown in FIG. 2 and described above in the Adaptive Code Generation section. However, the format shown in FIG. 2 is merely an example of any number of possible formats. Those skilled in the art will appreciate that the spirit and scope of the present invention is not limited to any one format of the processor feature set. Any set representation can be used.

Program feature set 1028 represents zero, one or more optional hardware features that machine code 1029 relies upon (i.e., zero, one or more optional hardware features that are required to execute machine code 1029). As noted above, the provenance of program feature set 1028 is unimportant for purposes of the present invention. The program feature set 1028 may, for example, be created by adaptive code generation or some other mechanism in a compiler, or be created outside a compiler by an analysis tool or the like. Machine code 1029 is the program's executable code. Executable program 1025 includes machine code 1029 and program feature set 1028. The program feature set 1028 may have the same format as exemplary program feature set format shown in FIG. 3 and described above in the Adaptive Code Generation section. However, the format shown in FIG. 3 is merely an example of any number of possible formats. Those skilled in the art will appreciate that the spirit and scope of the present invention is not limited to any one format of the program feature set. Any set representation can be used.

The executable program 1025 may have one or more dynamically linked libraries associated therewith. Dynamically linked library feature set 1010 represents zero, one or more optional hardware features that a dynamically linked library 1011 associated with executable program 1025 relies upon. Typically, a dynamically linked library is a file containing executable code and data bound to a program at load time or run time, rather than during linking. The code and data in a dynamically linked library can be shared by several applications simultaneously. Machine code 1012 is the dynamically linked library's executable code. Dynamically linked library 1011 includes machine code 1012 and dynamically linked library feature set 1010. The dynamically linked library feature set 1010 may have the same format as the exemplary program feature set format shown in FIG. 3 and described above in the Adaptive Code Generation section. However, the format shown in FIG. 3 is merely an example of any number of possible formats. Those skilled in the art will appreciate that the spirit and scope of the present invention is not limited to any one format of the dynamically linked library feature set. Any set representation can be used.

Run-time feature set 1015 represents zero, one or more optional hardware features process or thread 1016 relies upon (i.e., zero, one or more optional hardware features that are required to execute the process or thread). In accordance with the preferred embodiments of the present invention, each time code is loaded in a process, the features of the newly loaded code are OR-ed into the run-time feature set. The newly loaded code may include executable program 1025 or dynamically linked library 1011, or even dynamically generated code (such as that generated by a JIT compiler). A process may run a whole series of programs with different dynamically linked libraries before the process terminates. For example, although FIG. 1 shows only a single executable program 1025 and a single dynamically linked library 1011 for the sake of clarity, process 1015 may run several executable programs 1025 with different dynamically linked libraries 1011. Each executable program 1025 has a program feature set 1028, and each dynamically linked library 1011 has a dynamically linked library feature set 1010. The run-time feature set 1015 is generated by OR-ing the program feature set(s) 1028 and any associated dynamically linked library set(s) 1010. In the case of dynamically generated code, a dynamically generated code feature set acts like the feature set of a dynamically linked library in terms of updating the run-time feature set. That is, an updated run-time feature set is generated by OR-ing the feature set of the dynamically generated code into the run-time feature set.

The run-time feature set 1015, as well as the dynamically generated code feature set, may have the same format as the exemplary program feature set format shown in FIG. 3 and described above in the Adaptive Code Generation section. However, the format shown in FIG. 3 is merely an example of any number of possible formats. Those skilled in the art will appreciate that the spirit and scope of the present invention is not limited to any one format of these feature sets. Any set representation can be used.

In general, the feature sets (i.e., the processor feature sets; the program feature set(s); the dynamically linked library feature set(s), if any; the dynamically generated code feature set(s), if any; and the run-time feature set) need not have the same format as each other. Any set representation can be used for each feature set.

Note that data 1021, operating system 1022, system task dispatcher 1030, processor feature sets 1027A, 1027B, 1027C, and 1027D, process/thread 1016, run-time feature set 1015, executable program 1025, program feature set 1028, machine code 1029, dynamically linked library 1011, dynamically linked library feature set 1010, and machine code 1012 are all shown residing in memory 1020 for the convenience of showing all of these elements in one drawing. One skilled in the art will appreciate that this is not the normal mode of operation. Program feature set 1028, machine code 1029, and machine code 1012, may be generated on a computer system separate from computer system 1000. On yet another computer system, operating system 1022 generates run-time feature set 1015 and compares it to processor feature sets 1027A, 1027B, 1027C, and 1027D. Operating system 1022 will perform this check, and then invoke system task dispatcher 1030 to assign or reassign process or thread 1016 to one or more compatible processors, or potentially invoke a back-end compiler to rebuild executable program 1025, and/or any associated dynamically linked library 1010, and/or any dynamically generated code. The preferred embodiments of the present invention expressly extend to any suitable configuration and number of computer systems to accomplish these tasks. The “apparatus” described herein and in the claims expressly extends to a multiple computer configuration, as described by the example above.

Computer system 1000 utilizes well known virtual addressing mechanisms that allow the programs of computer system 1000 to behave as if they only have access to a large, single storage entity instead of access to multiple, smaller storage entities such as main memory 1020 and DASD device 155. Therefore, while data 1021, operating system 1022, system task dispatcher 1030, processor feature sets 1027A, 1027B, 1027C, and 1027D, process/thread 1016, run-time feature set 1015, executable program 1025, program feature set 1028, machine code 1029, dynamically linked library 1011, dynamically linked library feature set 1010, and machine code 1012 are shown to reside in main memory 1020, those skilled in the art will recognize that these items are not necessarily all completely contained in main memory 1020 at the same time. It should also be noted that the term “memory” is used herein to generically refer to the entire virtual memory of computer system 1000, and may include the virtual memory of other computer systems coupled to computer system 1000. For example, memory may exist in multiple levels of caches, and these caches may be further divided by function, so that one cache holds instructions while another holds non-instruction data which is to be used by the processors. Multiple CPUs may share a common main memory, and memory may further be distributed and associated with different CPUs or sets of CPUs, as is known in any of various so-called non-uniform memory access (NUMA) computer architectures.

Processors 110A, 110B, 110C, and 110D each may be constructed from one or more microprocessors and/or integrated circuits. Processors 110A, 110B, 110C, and 110D execute program instructions stored in main memory 1020. Main memory 1020 stores programs and data that processors 110A, 110B, 110C, and 110D may access. When computer system 1000 starts up, processors 110A, 110B, 110C, and 110D initially execute the program instructions that make up operating system 1022. Operating system 1022 is a sophisticated program that manages the resources of computer system 1000. Some of these resources are processors 110A, 110B, 110C, and 110D, main memory 1020, mass storage interface 130, display interface 140, network interface 150, and system bus 160. In accordance with the preferred embodiments of the present invention, operating system 1022 includes a system task dispatcher 1030 that dispatches process or thread 1016 to execute on one or more of the processors 110A, 110B, 110C, and 110D indicated as being compatible with process or thread 1016 by a comparison of the run-time feature set 1015 and the processor feature sets 1027A, 1027B, 1027C, and 1027D.

Although computer system 1000 is shown to contain only a single system bus, those skilled in the art will appreciate that the preferred embodiments of the present invention may be practiced using a computer system that has multiple buses. In addition, the interfaces that are used each include separate, fully programmed microprocessors that are used to off-load compute-intensive processing from processors 110A, 110B, 110C, and 110D. However, those skilled in the art will appreciate that the preferred embodiments of present invention apply equally to computer systems that simply use I/O adapters to perform similar functions.

Display interface 140 is used to directly connect one or more displays 165 to computer system 1000. These displays, which may be non-intelligent (i.e., dumb) terminals or fully programmable workstations, are used to allow system administrators and users to communicate with computer system 1000. Note, however, that while display interface 140 is provided to support communication with one or more displays 165, computer system 1000 does not necessarily require a display 165, because all needed interaction with users and other processes may occur via network interface 150.

Network interface 150 is used to connect other computer systems and/or workstations (e.g., 175 in FIG. 1) to computer system 1000 across a network 170. The preferred embodiments of the present invention apply equally no matter how computer system 1000 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the preferred embodiments of the present invention have been and will continue to be described in the context of a fully functional computer system, those skilled in the art will appreciate that present invention is capable of being distributed as a program product in a variety of forms, and that the preferred embodiments of the present invention apply equally regardless of the particular type of signal bearing media used to actually carry out the distribution. Examples of suitable signal bearing media include: recordable type media such as floppy disks and CD-RW (e.g., 195 in FIG. 1), and transmission type media such as digital and analog communications links.

A feature set is associated with each “load unit”, where a load unit is a collection of code that is always loaded as a single entity. This feature set may be generated by a compiler according to the methods of adaptive code generation, or through other means such as a separate analysis tool. According to the preferred embodiments of the present invention, load units may be executable programs, dynamically linked libraries, or dynamically generated code (e.g., code generated by a JIT compiler). With regard to the first type of load units (i.e., executable programs), a feature set is associated with each program (referred to herein as a “feature set of the program” or “program feature set”), indicating the features, if any, that the program relies upon (i.e., zero, one or more optional hardware features required to execute code contained in the program). The program feature set is recorded based on the use by the program of optional hardware features. With regard to the second type of load units (i.e., dynamically linked libraries), a feature set is also associated with each dynamically linked library (referred to herein as “feature set of the dynamically linked library” or “dynamically linked library feature set”), indicating the features, if any, that the dynamically linked library relies upon (i.e., zero, one or more optional hardware features required to execute code contained in the dynamically linked library). The dynamically linked library feature set is recorded based on the use by the dynamically linked library of optional hardware features. With regard to the third type of load units (i.e., dynamically generated code), a feature set is also associated with the dynamically generated code (referred to herein as “feature set of the dynamically generated code” or “dynamically generated code feature set”), indicating the features, if any, that the dynamically generated code relies upon (i.e., zero, one or more optional hardware features required to execute code contained in the dynamically generated code). The dynamically generated code feature set is recorded based on the use by the dynamically generated code of optional hardware features.

In addition, a feature set is associated with each process or thread (referred to herein as a “run-time feature set” or “feature set of the process” or “process's feature set”). Each time a load unit is loaded into a process, the feature set of the load unit is first OR-ed into the run-time feature set of the process. Over time, the load units may include one or more programs, zero or more dynamically linked libraries, and even perhaps some dynamically generated code (e.g., code generated by a JIT compiler). The run-time feature set is defined as the union of the program feature set(s), the feature set(s) of any associated dynamically linked libraries, and the feature set(s) of any dynamically generated code. Whenever the run-time feature set will change due to new features in the code about to be loaded, the operating system first determines if there are available processors that can support the new run-time feature set. If so, the code is loaded, and the process gives up its time slice. The next time the process is dispatched, the system task dispatcher will assign one or more processors with all the required features.

If no processor with all required features exists, then the code (i.e., the new load unit) cannot be loaded. Options at this point include taking an exception or forcing the new load unit to be rebuilt with fewer features before being loaded. In the latter case, adaptive code generation may be used as described in related U.S. patent application ______ (docket no. ROC920050022US1), filed concurrently, entitled “METHOD, APPARATUS, AND COMPUTER PROGRAM PRODUCT FOR ADAPTIVELY GENERATING CODE FOR A COMPUTER PROGRAM”, which is assigned to the assignee of the instant application, and which is hereby incorporated herein by reference in its entirety. For example, the new load unit may be automatically rebuilt from its intermediate representation to take advantage of only those features of available processors by applying the processor feature set(s).

As mentioned above, the load unit may include dynamically generated code. Such a load unit may be generated, for example, when a JIT compiler exploits one or more features in generating code that were not previously used in the running process. For example, the JIT compiler may select a procedure for compilation or recompilation based on some criteria, such as high use. According to the preferred embodiments of the present invention, the JIT compiler would cause the operating system to update the run-time feature set of the process to include the new feature(s) before returning control to the code, and the process would then give up its time slice. When next dispatched, the process would run the newly compiled code on one or more available processors that can support the updated run-time feature set.

In the preferred embodiments of the present invention, the run-time feature set is non-decreasing. That is, once a feature is added to the run-time feature set, it stays there until termination of the process or thread. This is conservative, but is often necessary because typically it is unknown whether a process or thread is finished with a dynamically linked library. It is possible in some computer systems for a dynamically linked library to be explicitly unloaded, but this is rarely used in practice. In such a computer system where explicit unloading of dynamically linked libraries is possible, an alternative embodiment of the present invention may be used. For example, the run-time feature set may be implemented as a count vector (rather than a simple set) tracking how many load units have requested the use of each feature. The count for a feature would be incremented when a load unit requiring the feature is loaded, and decremented when such a load unit is unloaded. When the count for a feature reaches zero, the feature is no longer required by the process or thread for processor compatibility. Those skilled in the art will appreciate that other variations beyond this particular count vector implementation are possible within the spirit and scope of the present invention.

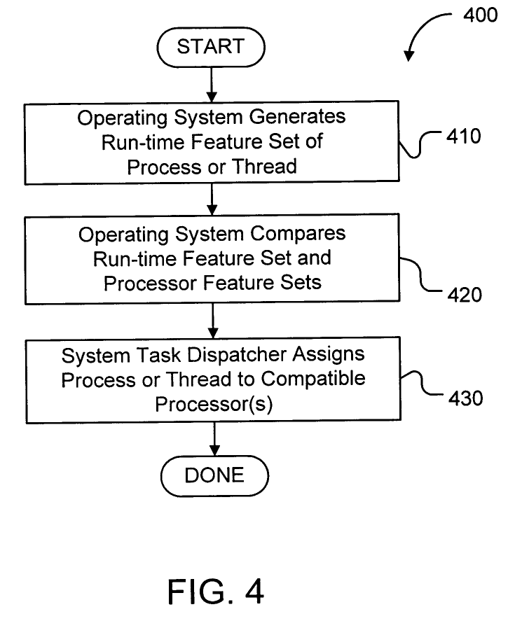

FIG. 4 is a flow diagram showing a method 400 for adaptive process dispatch by generating a run-time feature set of a process or a thread in accordance with the preferred embodiments of the present invention. Method 400 begins by generating a run-time feature set of a process or thread (step 410). The run-time feature set is generated by the operating system each time a load unit is loaded into a process by OR-ing the feature set of the load unit into the run-time feature set of the process (a new top-level process or an existing process). Over time, the feature sets of the load units may include one or more program feature set(s), the feature set(s) of zero or more associated dynamically linked libraries, and the feature set(s) of any dynamically generated code. Whenever the run-time feature set will change due to new features in the code about to be loaded, the operating system first determines if there are available processors that can support the new run-time feature set. This is accomplished by comparing the run-time feature set and at least one processor feature set (step 420). This comparison of the feature sets determines whether a particular process or thread may run on a particular processor. If there are available processors that can support the new run-time feature set, the code is loaded, and the process gives up its time slice. The next time the process is dispatched, the system task dispatcher will assign the process to execute on one or more processors with all the required features (step 430). Thus, even in a heterogeneous processor environment, the process or thread will not be assigned to execute on an incompatible processor. If a compatible processor is not resident on the computer system, then the code (i.e., new load unit) cannot be loaded, and an exception is taken or the new load unit (which includes one or more features not supported by the available processors) may be rebuilt according to adaptive code generation.

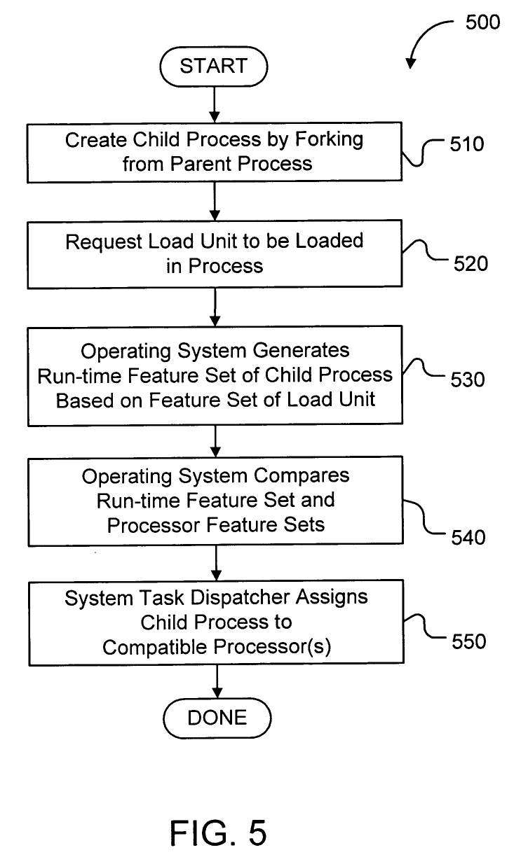

FIG. 5 is a flow diagram showing a method 500 for adaptive process dispatch by generating a run-time feature set of a child process in accordance with the preferred embodiments of the present invention. Processes are created by “forking” from a parent process (step 510), and each process inherits its parent's feature set at creation time. When a process forks, an exact copy of that process is created. After forking, the child process typically loads and executes a program (step 520). Method 500 continues by generating a run-time feature set of the process (step 530). The run-time feature set is generated by the operating system each time a load unit is loaded into a process by OR-ing the feature set of the load unit into the run-time feature set of the child process. Over time, the feature sets of the load units may include one or more program feature set(s), the feature set(s) of zero or more associated dynamically linked libraries, and the feature set(s) of any dynamically generated code. Whenever the run-time feature set will change due to new features in the code about to be loaded, the operating system first determines if there are available processors that can support the new run-time feature set. This is accomplished by comparing the run-time feature set and at least one processor feature set (step 540). This comparison of the feature sets determines whether the child process may run on a particular processor. If there are available processors that can support the new run-time feature set, then the code is loaded, and the process gives up its time slice. The next time the process is dispatched, the system task dispatcher will assign the process to execute on one or more processors with all the required features (step 550). Thus, even in a heterogeneous processor environment, the child process will not be assigned to execute on an incompatible processor. If a compatible processor is not resident on the computer system, then the code (i.e., new load unit) cannot be loaded, and an exception is taken or the new load unit (which includes one or more features not supported by the available processors) may be rebuilt according to adaptive code generation.

As noted above, the present invention can be applied to threads. A thread inherits its feature set from its parent thread, and modifies its feature set in the same way until termination. Thus, in an alternative embodiment of the present invention, method 500 shown in FIG. 5 may be modified to apply to a thread in lieu of a process.

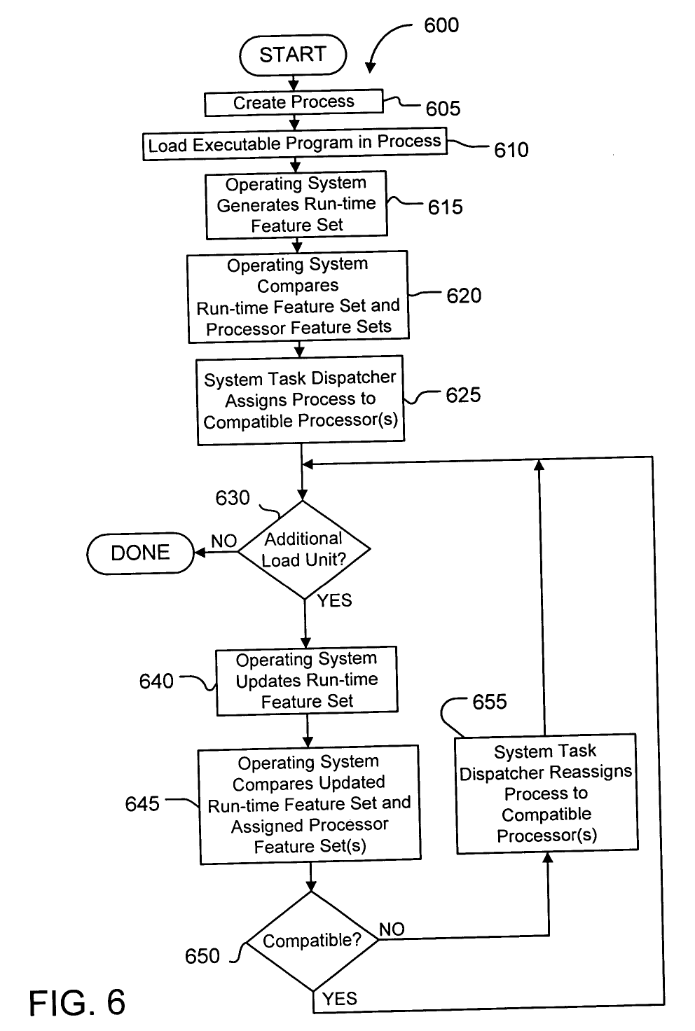

FIG. 6 is a flow diagram showing a method 600 for adaptive process dispatch by generating an updated run-time feature set of a process when an additional load unit is requested to be loaded in accordance with the preferred embodiments of the present invention. A new process is created (step 605) and loads a program to be executed (step 610). At that time, the operating system generates a run-time feature set of the process (step 615). The operating system determines if there are available processors that can support the run-time feature set. This is accomplished by comparing the run-time feature set of the process to at least one processor feature set (step 620). This comparison of the feature sets determines whether the process may run on a particular processor. If there are available processors that can support the run-time feature set, the code is loaded, and the system task dispatcher will assign the process to execute on one or more processors with all the required features (step 625).

Method 600 continues by making a determination as to whether an additional load unit remains to be loaded (step 630). Over time, the additional load units may include one or more additional executable program(s), zero or more associated dynamically linked libraries, and dynamically generated code. If no additional load unit remains to be loaded (step 630: NO), method 600 ends. On the other hand, if an additional load unit remains to be loaded (step 630: YES), its feature set and the current run-time feature set are OR-ed to generate an updated run-time feature set (step 640). Next, the updated run-time feature set of the process is compared to the processor feature set of the processor to which the process is currently assigned (step 645). This comparison of the feature sets determines whether the modified process may run on the currently assigned processor. When a process's feature set is modified, the system task dispatcher is queried to see whether the process is still compatible with the processor on which the process is running. If the process is still compatible with the currently assigned processor (step 650: YES), then the code is loaded, and method 600 returns to step 630. On the other hand, if the process is no longer compatible with the currently assigned processor (step 650: NO) and there are not available processors that are compatible, then the code cannot be loaded, and the process gives up its time slice. If there are available processors that can support the updated run-time feature set, then code is loaded, and the process gives up its time slice. The next time the process is dispatched, the system task dispatcher will move the process to a compatible processor (step 655). Then, method 600 returns to step 630. Thus, even when a process is modified in a heterogeneous processor environment, the process will not be assigned to execute on an incompatible processor. If a compatible processor is not resident on the computer system, then the code (i.e., the most recently requested load unit) cannot be loaded, and an exception is taken or the most recently requested load unit may be rebuilt according to adaptive code generation.

One skilled in the art will appreciate that many variations are possible within the scope of the present invention. Thus, while the present invention has been particularly shown and described with reference to preferred embodiments thereof, it will be understood by those skilled in the art that these and other changes in form and details may be made therein without departing from the spirit and scope of the present invention.

What is claimed is:

1. A method for adaptive process dispatch in a computer system having a plurality of processors, the method comprising the steps of:
generating a run-time feature set of a process or a thread;
comparing the run-time feature set of the process or the thread and at least one processor feature set, each processor feature set being associated with one or more of the processors;
assigning the process or the thread to execute on one or more of the processors indicated by the comparing step as being compatible with the process or the thread.

2. The method for adaptive process dispatch in a computer system having a plurality of processors of claim 1, wherein the processors are members of a processor architecture family and each processor feature set represents zero, one or more optional hardware features of the processor architecture family supported by the one or more processors with which the processor feature set is associated, and wherein the run-time feature set represents zero, one or more optional hardware features the process or the thread relies upon.

3. The method for adaptive process dispatch in a computer system having a plurality of processors of claim 1, wherein the at least one processor feature set includes a first processor feature set and a second processor feature set contained in an operating system (OS) of the computer system, and wherein the one or more processors with which the first processor feature set is associated is/are heterogeneous with respect to the one or more processors with which the second processor feature set is associated.

4. A method for adaptive process dispatch in a computer system having a plurality of processors, the method comprising the steps of:
creating a process;
requesting a load unit to be loaded in the process, wherein the load unit has associated therewith a feature set;
generating a run-time feature set based on the feature set of the load unit;
comparing the run-time feature set and at least one processor feature set, each processor feature set being associated with one or more of the processors;
assigning the process to execute on one or more of the processors indicated by the comparing step as being compatible with the process.

5. The method for adaptive process dispatch in a computer system having a plurality of processors of claim 4, wherein the processors are members of a processor architecture family and each processor feature set represents zero, one or more optional hardware features of the processor architecture family supported by the one or more processors with which the processor feature set is associated, and wherein the run-time feature set represents zero, one or more optional hardware features the process relies upon.

6. The method for adaptive process dispatch in a computer system having a plurality of processors of claim 4, wherein the at least one processor feature set includes a first processor feature set and a second processor feature set contained in an operating system (OS) of the computer system, and wherein the one or more processors with which the first processor feature set is associated is/are heterogeneous with respect to the one or more processors with which the second processor feature set is associated.

7. The method for adaptive process dispatch in a computer system having a plurality of processors of claim 4, wherein the load unit is a collection of code loaded as a single entity.

8. The method for adaptive process dispatch in a computer system having a plurality of processors of claim 4, wherein the load unit is one of an executable program, a dynamically linked library, and dynamically generated code.

9. The method for adaptive process dispatch in a computer system having a plurality of processors of claim 4, wherein the step of requesting a load unit to be loaded in the process includes the step of loading one of an executable program, a dynamically linked library, and dynamically generated code having associated therewith a feature set, and the step of generating a run-time feature set includes the step of OR-ing the feature set of the executable program, dynamically linked library, or dynamically generated code into a previously generated run-time feature set.

10. The method for adaptive process dispatch in a computer system having a plurality of processors of claim 4, further comprising the steps of:
subsequently requesting another load unit to be loaded in the process, wherein the another load unit has associated therewith a feature set;
updating the run-time feature set by OR-ing the feature set of the another load unit and the run-time feature set;
comparing the updated run-time feature set and at least one processor feature set;
if the step of comparing the updated run-time feature set and at least one processor feature set indicates one or more of the processors to which the assigning step assigned the process as being incompatible with the process, reassigning the process to execute on one or more of the processors indicated as being compatible with the process by the step of comparing the updated run-time feature set and at least one processor feature set.

11. The method for adaptive process dispatch in a computer system having a plurality of processors of claim 10, wherein the processors are members of a processor architecture family and each processor feature set represents zero, one or more optional hardware features of the processor architecture family supported by the one or more processors with which the processor feature set is associated, and wherein the updated run-time feature set of the process represents zero, one or more optional hardware features the process relies upon.

12. The method for adaptive process dispatch in a computer system having a plurality of processors of claim 10, wherein the requesting step includes the step of requesting the loading of a first executable program, and wherein the subsequently requesting step includes the step of requesting the loading one of a second executable program, a dynamically linked library, and dynamically generated code.

13. The method for adaptive process dispatch in a computer system having a plurality of processors of claim 10, wherein the requesting step includes the step of requesting the loading of dynamically generated code, and wherein the subsequently requesting step includes the step of requesting the loading one of an executable program, a dynamically linked library, and other dynamically generated code.

14. A computer program product for adaptive process dispatch in a digital computing device having a plurality of processors, comprising:
a plurality of executable instructions recorded on signal-bearing media, wherein the executable instructions, when executed by at least one of the processors, cause the digital computing device to perform the steps of:
creating a process;
requesting a load unit to be loaded in the process, wherein the load unit has associated therewith a feature set;
generating a run-time feature set based on the feature set of the load unit;
comparing the run-time feature set and at least one processor feature set, each processor feature set being associated with one or more of the processors;
assigning the process to execute on one or more of the processors indicated by the comparing step as being compatible with the process.

15. The computer program product for adaptive process dispatch in a digital computing device having a plurality of processors of claim 14, wherein the processors are members of a processor architecture family and each processor feature set represents zero, one or more optional hardware features of the processor architecture family supported by the one or more processors with which the processor feature set is associated, and wherein the run-time feature set represents zero, one or more optional hardware features the process relies upon.

16. The computer program product for adaptive process dispatch in a digital computing device having a plurality of processors of claim 14, wherein the at least one processor feature set includes a first processor feature set and a second processor feature set contained in an operating system (OS) of the digital computing device, and wherein the one or more processors with which the first processor feature set is associated is/are heterogeneous with respect to the one or more processors with which the second processor feature set is associated.

17. The computer program product for adaptive process dispatch in a digital computing device having a plurality of processors of claim 14, wherein the load unit is loaded as a single entity and is one of an executable program, a dynamically linked library, and dynamically generated code.

18. The computer program product for adaptive process dispatch in a digital computing device having a plurality of processors of claim 14, wherein the step of requesting a load unit to be loaded in the process includes the step of loading one of an executable program, a dynamically linked library, and dynamically generated code having associated therewith a feature set, and wherein the step of generating a run-time feature set includes the step of OR-ing the feature set of the executable program, dynamically linked library, or dynamically generated code into a previously generated run-time feature set.

19. The computer program product for adaptive process dispatch in a digital computing device having a plurality of processors of claim 14, wherein the executable instructions, when executed by at least one processor of the digital computing device, cause the digital computing device to further perform the steps of:
subsequently requesting another load unit to be loaded in the process, wherein the another load unit has associated therewith a feature set;
updating the run-time feature set by OR-ing the feature set of the another load unit and the run-time feature set of the process;
comparing the updated run-time feature set and at least one processor feature set;
if the step of comparing the updated run-time feature set and at least one processor feature set indicates one or more of the processors to which the assigning step assigned the process as being incompatible with the process, reassigning the process to execute on one or more of the processors indicated as being compatible with the process by the step of comparing the updated run-time feature set and at least one processor feature set.

20. An apparatus comprising:
a plurality of processors;
a memory coupled to one or more of the processors;
an executable program, wherein the executable program has associated therewith a feature set;
a process, wherein the process loads and executes the executable program;
an adaptive process dispatch mechanism residing in the memory and executed by one or more of the processors, the adaptive process dispatch mechanism comprising:
a run-time feature set generating function which generates a run-time feature set based on the feature set of the executable program;
a comparing function which compares the run-time feature set and at least one processor feature set, each processor feature set being associated with one or more of the processors;
a task dispatcher residing in the memory and executed by one or more of the processors, the system task dispatcher comprising:
an assigning function which assigns the process to execute on one or more of the processors indicated by the comparing function as being compatible with the process.

21. The apparatus of claim 20, wherein the processors are members of a processor architecture family and each processor feature set represents zero, one or more optional hardware features of the processor architecture family supported by the one or more processors with which the processor feature set is associated, and wherein the run-time feature set represents zero, one or more optional hardware features the process relies upon.

22. The apparatus of claim 20, wherein the at least one processor feature set includes a first processor feature set and a second processor feature set contained in an operating system (OS) of the apparatus, and wherein the one or more processors with which the first processor feature set is associated is/are heterogeneous with respect to the one or more processors with which the second processor feature set is associated.

23. The apparatus of claim 20, wherein the run-time feature set generating function generates an updated run-time feature set when a request is made to load a load unit in the process by OR-ing the run-time feature set and a feature set of the load unit, and wherein the load unit is one of another executable program, a dynamically linked library, and dynamically generated code.
